(19) United States
(12) Patent Application Publication
(10) Pub. No.: US 2016/0262359 A1
(43) Pub. Date: Sep. 15, 2016

(54) HONEYCOMB UNCAPPING DEVICE AND METHODS

(71) Applicant: Jason Gouedy, Loranger, LA (US)

(72) Inventor: Jason Gouedy, Loranger, LA (US)

(21) Appl. No.: 15/049,768

(22) Filed: Feb. 22, 2016

Related U.S. Application Data
(60) Provisional application No. 62/133,409, filed on Mar. 15, 2015.

(51) Int. Cl. A01K 59/02

(52) U.S. Cl. CPC A01K 59/02

(57) ABSTRACT

In some embodiments, a honeycomb uncapping device may include a support structure with a first uncapping roller and a second uncapping roller. The first uncapping roller may be rotatably coupled to the support structure and may have a plurality of projections that radiate away from the first uncapping roller. The second uncapping roller may be rotatably coupled to the support structure and may have a plurality of projections that radiate away from the second uncapping roller. A channel for receiving a honeycomb frame having a honeycomb may be formed between the first and second uncapping roller. A tensioning element may be coupled to the first and/or second uncapping roller. The tensioning element may tension the second uncapping roller towards the first uncapping roller to tension the first and second uncapping rollers into contact with opposing sides of the honeycomb as the honeycomb frame is moved through the channel.

### CROSS REFERENCE TO RELATED APPLICATIONS

This application claims priority to and the benefit of the filing date of U.S. Provisional Application No. 62/133,409, filed on Mar. 15, 2015, entitled “HONEYCOMB UNCAPPING DEVICE AND METHODS”, which is hereby incorporated by reference in its entirety.

### FIELD OF THE INVENTION

This patent specification relates to the field of devices and methods for removing wax cappings from honeycombs. More specifically, this patent specification relates to devices and methods for removing wax cappings from both sides of a honeycomb disposed within a honeycomb frame.

### BACKGROUND

In the honeybee hive, honey is contained in small cells that are covered with wax cappings. These cells are collectively referred to as honeycomb. In domestic bee hives this honeycomb is generally built by the honey bees on both sides of a rectangular honeycomb frame that can be removed from the hive box for the extraction of honey. The integrity of the wax cappings must be broken to allow the removal of honey from the honeycomb during the extraction process. This process is often referred to as uncapping.

The uncapping of honeycombs usually involves the use of sharp knives, heat, electricity, steam, or varied combinations of these methods. Existing methods of uncapping requiring knives or a source of electricity or steam can only be used where these items are available and generally involve heavy, complicated, machinery with many moving parts along with a facility to house the apparatus. For this reason, the locations at which these methods may be performed are limited.

After a frame of honeycomb is removed from the bee hive and uncapped, it is placed into a honey extractor. A honey extractor is a mechanical device that extracts the honey from the honeycomb without destroying the comb. Extractors work by centrifugal force. A drum holds a frame basket which spins the uncapped frames, flinging the honey out. The extracted honey is then filtered into a pure liquid form for use.

While there are currently available honeycomb uncapping devices, most of these devices require the use of motor driven cylinders with different configurations and a mechanical feeding mechanism to uncap honeycomb. However, most of all of these machines are large, rely on electricity and motor driven parts, and cause unnecessary damage to the honeycomb. The price of these currently available machines put them out of reach for the small to medium sized honey producer leaving them with messy and wasteful methods of uncapping honeycomb.

Therefore, a need exists for novel devices and methods for removing wax cappings from honeycombs. There exists a further need for quick and highly portable novel devices and methods for removing wax cappings from honeycombs which do not require the use of sharp knives, electricity or any source of heat or electricity. There also exist a need for honeycomb uncapping devices and methods that can be easily stored when not in use making it very desirable for the hobby beekeeper since honey production is a seasonal pursuit and also for the larger beekeeper who keeps his bees in several locations can easily harvest honey at different locations instead of making many trip to and from the bee yards, saving time and money.

### BRIEF SUMMARY OF THE INVENTION

A honeycomb uncapping device for uncapping wax from both sides of a honeycomb disposed within a honeycomb frame is provided. In some embodiments, the device may include a support structure with a first uncapping roller and a second uncapping roller. The first uncapping roller may be rotatably coupled to the support structure and may have a plurality of projections that radiate away from the first uncapping roller. The second uncapping roller may be rotatably coupled to the support structure and may have a plurality of projections that radiate away from the second uncapping roller. A channel for receiving a honeycomb frame having a honeycomb may be formed between the first uncapping roller and the second uncapping roller. A tensioning element may be coupled to the first uncapping roller and/or to the second uncapping roller. The tensioning element may tension the second uncapping roller towards the first uncapping roller to tension the first uncapping roller and the second uncapping roller into contact with opposing sides of the honeycomb as the honeycomb frame is moved through the channel.

In further embodiments, the first and/or second uncapping roller may also be movably coupled to the support structure to allow the first and/or second uncapping roller to be moved relative to the other uncapping roller.

According to one aspect consistent with the principles of the invention, a method for uncapping a honeycomb is provided. The method may include positioning a honeycomb disposed within a honeycomb frame above the channel of a honeycomb uncapping device; moving the honeycomb frame with the honeycomb into the channel; rotating the uncapping rollers across opposing sides of the honeycomb; and removing the honeycomb disposed within the honeycomb frame from the channel.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of a honeycomb uncapping device according to various embodiments described herein.

FIG. 2 illustrates a top perspective view of an alternative example of a honeycomb uncapping device according to various embodiments described herein.

FIG. 3 shows a top perspective view of an example of a honeycomb uncapping device receiving an example honeycomb disposed within a honeycomb frame according to various embodiments described herein.

FIG. 4 depicts a perspective view of a further alternative example of a honeycomb uncapping device and an example honeycomb disposed within a honeycomb frame according to various embodiments described herein.

FIG. 5 illustrates a perspective view of a further alternative example of a honeycomb uncapping device receiving an example honeycomb disposed within a honeycomb frame according to various embodiments described herein.

FIG. 6 shows a sectional, through line 6-6 shown in FIG. 5, elevation view of an example of a honeycomb uncapping device receiving an example honeycomb disposed within a honeycomb frame according to various embodiments described herein.

FIG. 7A depicts a partial elevation view of an example of a honey comb according to various embodiments described herein.

FIG. 7B illustrates a partial elevation view of an example of an uncapping roller according to various embodiments described herein.

FIG. 8 illustrates an elevation view of an example of a honeycomb uncapping device showing a major wall according to various embodiments described herein.

FIG. 9 shows a sectional, through line 9-9 shown in FIG. 8, elevation view of an example of a honeycomb uncapping device according to various embodiments described herein.

FIG. 10 depicts an elevation view of an example of a honeycomb uncapping device showing a minor wall according to various embodiments described herein.

FIG. 11 illustrates a partial sectional, through line 11-11 shown in FIG. 10, plan view of an example of a honeycomb uncapping device according to various embodiments described herein.

FIG. 12 shows a block diagram of an example of a method for uncapping a honeycomb according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

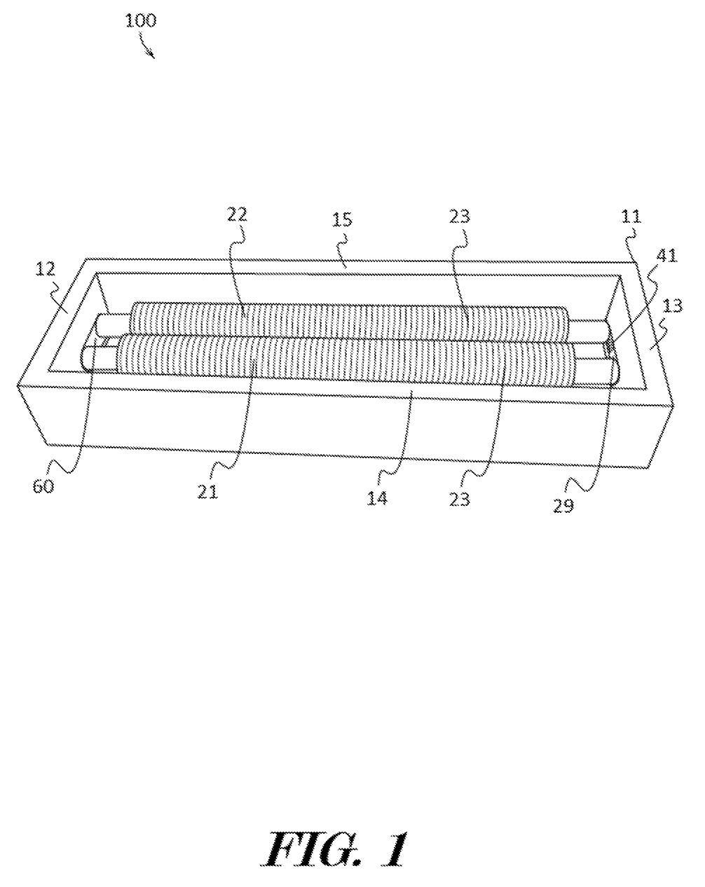

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

New honeycomb uncapping devices and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

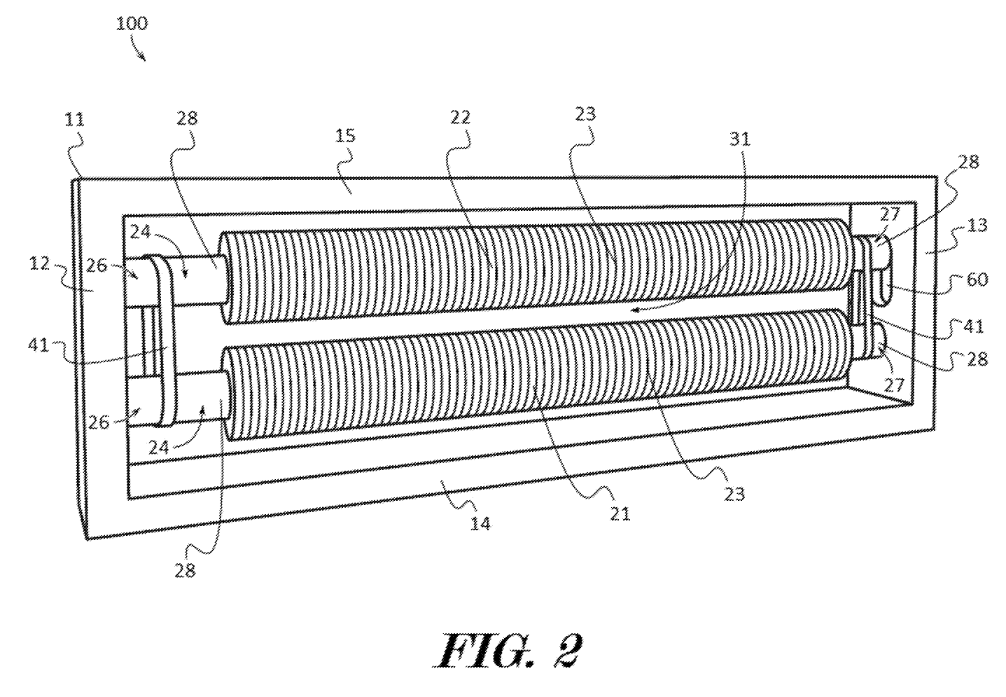

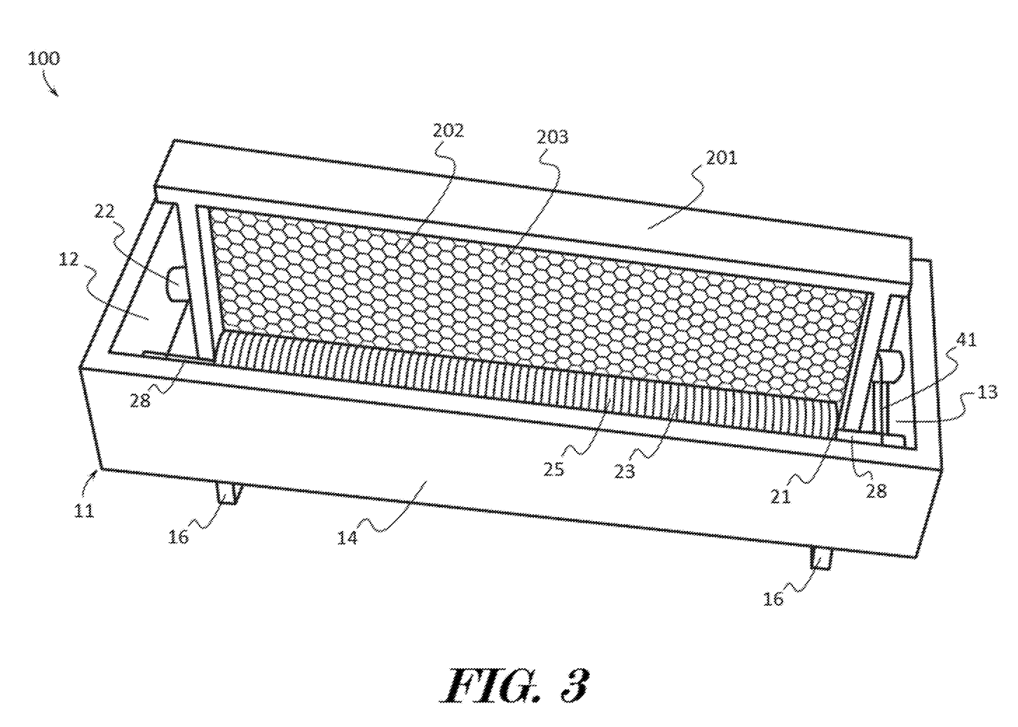

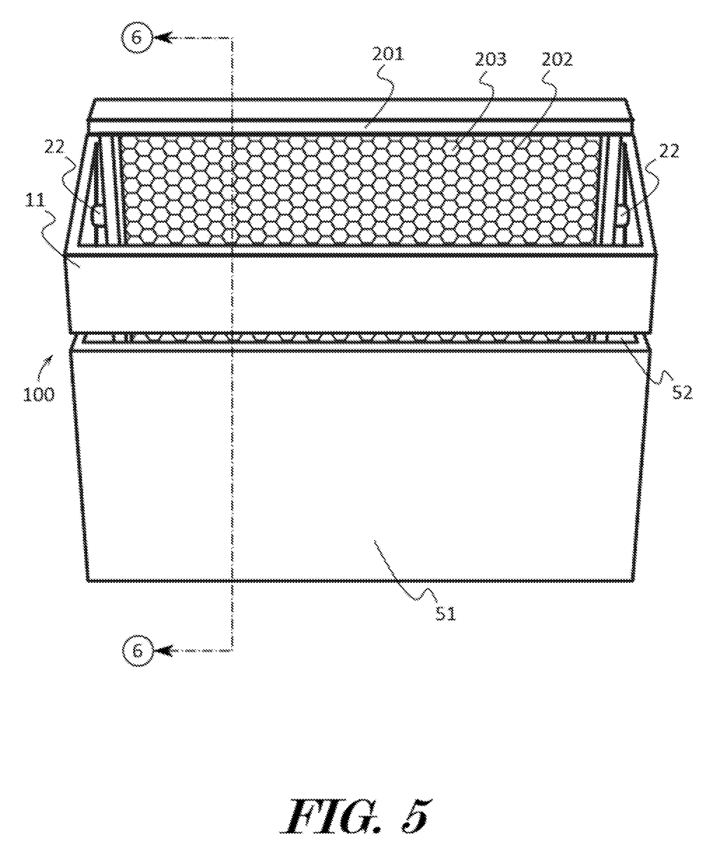

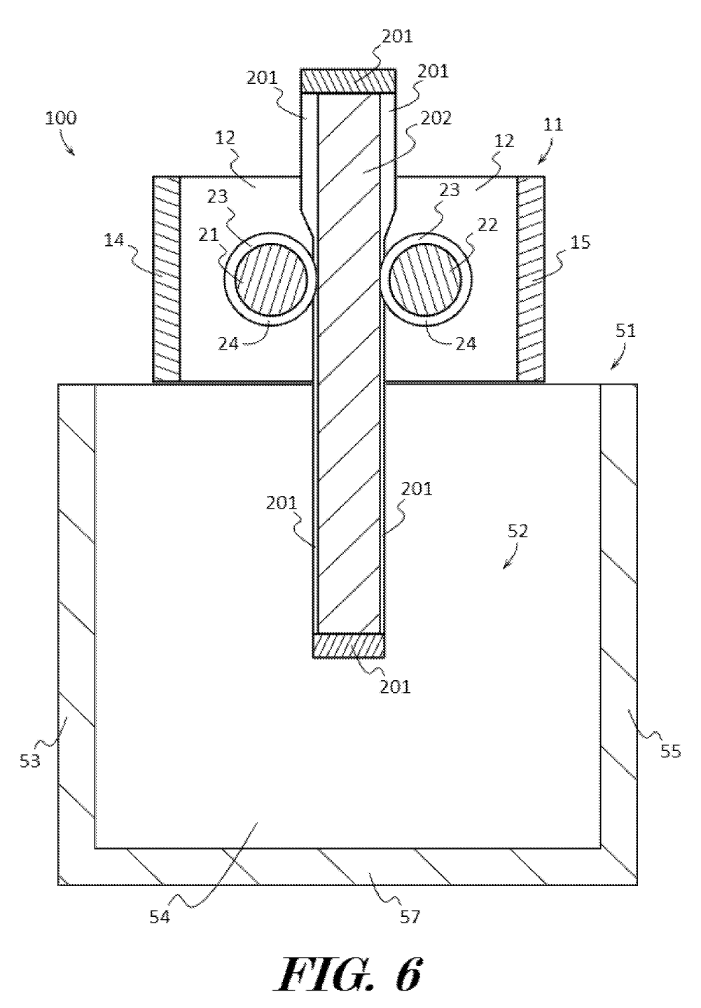

The present invention will now be described by example and through referencing the appended figures representing preferred and alternative embodiments. FIGS. 1 and 2 illustrate an example of a honeycomb uncapping device (“the device”) 100 according to various embodiments. In some embodiments, the device 100 may comprise a support structure 11 with a first uncapping roller 21 and a second uncapping roller 22. The first uncapping roller 21 may be rotatably coupled to the support structure 11 and may comprise a plurality of projections 23 that radiate away from the first uncapping roller 21. The second uncapping roller 22 may be rotatably coupled to the support structure 11 and may comprise a plurality of projections 23 that radiate away from the second uncapping roller 22. Optionally, the first 21 and/or second uncapping roller 22 may also be movably coupled to the support structure 11 to allow the first 21 and/or second uncapping roller 22 to be moved relative to the other uncapping roller 21, 22. A channel 31 for receiving a honeycomb frame 201 (FIGS. 3-6) having a honeycomb 202 (FIGS. 3-7A) may be formed between the first uncapping roller 21 and the second uncapping roller 22. A tensioning element 41 may be coupled to the first uncapping roller 21 and/or to the second uncapping roller 22. The tensioning element 41 may tension the second uncapping roller 22 towards the first uncapping roller 21 to tension the first uncapping roller 21 and the second uncapping roller 22 into contact with opposing sides of the honeycomb 202 as the honeycomb frame 201 is moved through the channel 31 as perhaps best shown in FIG. 6.

Turning now to FIGS. 3-7A, the device 100 is configured to remove wax cappings from honeycombs 202 which are disposed in a honeycomb frame 201. Typically, a honeycomb 202 is a mass of hexagonal wax cells 203 built by honey bees in their hive nests to contain their larvae and stores of honey and pollen. Wax cells 203 comprising honey are capped with a wax cover to keep the honey within the wax cells 203. A honeycomb frame 202 may comprise a rectangular structure into which a plurality of wax cells 203 may be deposited by the bees. The honeycomb frame 202 supports the wax cells 203 and also provides a structure for removing the plurality of wax cells 203 disposed within the honeycomb frame 202 from a bee hive to harvest the honey.

As shown in FIGS. 1-6, the uncapping rollers 21, 22, may be rotatably coupled to the support structure 11. In some embodiments, the support structure 11 may be configured in the shape of a three dimensional rectangle which may be formed by two opposing and generally parallel minor walls 12, 13, and two opposing and generally parallel major walls 14, 15. The major walls 14, 15 and the minor walls 12, 13, may be generally perpendicularly coupled to each other. In alternative embodiments, the support structure 11 may be configured in a plurality of sizes and shapes including “C” shaped, “U” shaped, square shaped, cylinder shaped, hexagonal prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

In some embodiments, the support structure 11 or elements which may comprise the support structure 11, such as the minor 12, 13, and major 14, 15, walls may be formed from or comprise a rigid material. In further embodiments, a rigid material may include steel alloys, aluminum, aluminum alloys, copper alloys, any other type of metal or metal alloy, any type of ceramics, earthenware, natural stone, synthetic stone, various types of hard plastics, such as nylon, acrylic, uPVC, HDPE, melamine, hard rubbers, fiberglass, carbon fiber, resins, such as epoxy resin, wood or any other material including combinations of materials that are substantially rigid.

The device 100 may comprise two or more uncapping rollers, such as a first uncapping roller 21 and a second uncapping roller 22. Generally, the uncapping rollers 21, 22, may comprise an elongated cylindrical shape which may extend between two opposing walls, such as between the two minor walls 12, 13. Each uncapping roller 21, 22, may comprise a first end 26 and a second end 27 and the ends 26, 27, of the uncapping rollers 21, 22, may be coupled to the minor walls 12, 13. In some embodiments, the uncapping rollers 21, 22, may comprise substantially the same shape and dimensions. In other embodiments, one uncapping roller 21, 22, may comprise an elongated cylindrical shape with a larger or smaller diameter than the other uncapping roller 21, 22. The uncapping rollers 21, 22, may be made from a rigid food-grade material such as stainless steel although any other substantially rigid material suitable for contacting a honeycomb 202 may be used.

Referencing FIGS. 1-4, and 7B, each uncapping roller 21, 22, may comprise a plurality of projections 23 which may radiate away from the uncapping roller 21, 22. A projection 23 may be configured in any size or shape extending away from the roller surface 24 of the uncapping roller 21, 22. A valley 25 may be formed between two adjacent projections 23 and the roller surface 24 of the uncapping roller 21, 22. In this manner, each uncapping roller 21, 22, comprising a plurality of projections 23 may also comprise a plurality of valleys 25.

In some embodiments, the projections 23 of the first uncapping roller 21 may be cylindrical and may encircle the roller surface 24 of the first uncapping roller 21. The valleys 25 between the cylindrical projections 23 may therefore also be cylindrical and may encircle the first uncapping roller 21. In other embodiments, the projections 23 may be wavy and may encircle the roller surface 24 of the first uncapping roller 21 so that the valleys 25 between the cylindrical projections 23 may therefore also be wavy and may encircle the first uncapping roller 21. In alternative embodiments, the projections 23 may not encircle the first uncapping roller 21 but may be discreet rods, poles, pyramids, cones, or any other shape which may extend or radiate away from the first uncapping roller 21 with a valley 25 separating each projection 23.

In some embodiments, the projections 23 of the second uncapping roller 22 may be cylindrical and may encircle the roller surface 24 of the second uncapping roller 22. The valleys 25 between the cylindrical projections 23 may therefore also be cylindrical and may encircle the second uncapping roller 22. In other embodiments, the projections 23 may be wavy and may encircle the roller surface 24 of the second uncapping roller 22 so that the valleys 25 between the cylindrical projections 23 may therefore also be wavy and may encircle the second uncapping roller 22. In alternative embodiments, the projections 23 may not encircle the second uncapping roller 22 but may be discreet rods, poles, pyramids, cones, or any other shape which may extend or radiate away from the second uncapping roller 22 with a valley 25 separating each projection 23.

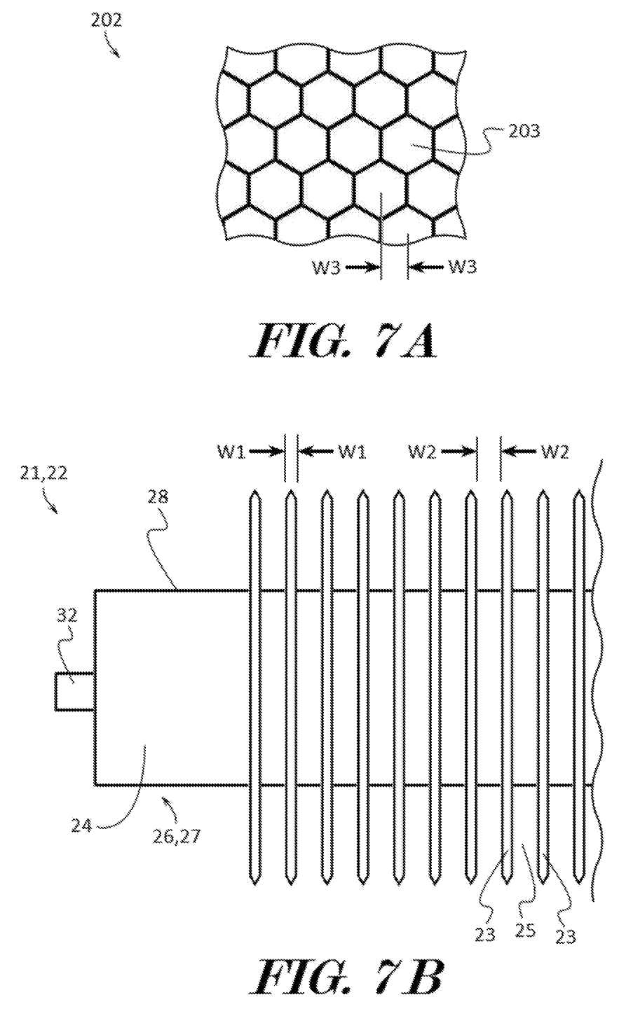

As perhaps best shown by FIG. 7B, each projection 23 may comprise a width dimension (W1) and each valley 25 may comprise a width dimension (W2). Likewise, a honeycomb 202 may comprise a width dimension (W3) which may describe the approximate distance between the center of a first wax cell 203 and a second wax cell 203 in contact with the first wax cell 203. In preferred embodiments, the W1 of each projection 23 may be generally equal to the W1 of the other projections 23 on the uncapping rollers 21, 22. In further preferred embodiments, the W2 of each valley 25 may be generally equal to the W2 of the other valleys 25 on the uncapping rollers 21, 22. In further preferred embodiments, the W1 of each projection 23 may be less than or equal to the W3 of the honeycomb 202. In still further preferred embodiments, the W2 of each valley 25 may be less than or equal to the W3 of the honeycomb 202.

Referring now to FIG. 2, in some embodiments, one or more uncapping rollers 21, 22, may comprise a frame depression 28 proximate to the first end 26 and to the second end 27 of the respective uncapping roller 21, 22. A frame depression 28 may form a recess on the uncapping rollers 21, 22, for receiving portions of a honeycomb frame 201 (FIGS. 3-6) thereby allowing the projections 23 to contact a honeycomb 202 (FIGS. 3-7A) disposed within the frame which is typically narrower in width than the honeycomb frame 201 as shown in FIG. 6. In preferred embodiments, the first 21 and second 22 uncapping rollers may each comprise two frame depressions 28 bounding the plurality of projections 23 on each uncapping roller 21, 22. A first frame depression 28 may be formed on a first uncapping roller 21 by the roller surface 24 between the projection 23 closest to a first minor wall 12 and the first minor wall 12. Likewise, a second frame depression 28 may be formed on the first uncapping roller 21 by the roller surface 24 between the projection 23 closest to a second minor wall 13 and the second minor wall 13. A first frame depression 28 may be formed on a second uncapping roller 22 by the roller surface 24 between the projection 23 closest to a first minor wall 12 and the first minor wall 12. Likewise, a second frame depression 28 may be formed on the second uncapping roller 22 by the roller surface 24 between the projection 23 closest to a second minor wall 13 and the second minor wall 13.

Each uncapping roller 21, 22, may be rotatably coupled to the support structure 11, such as to the minor walls 12, 13, thereby allowing each uncapping roller 21, 22, to rotate freely and independently. Preferably, the first 26 and second 27 ends of each uncapping roller 21, 22, may be rotatably coupled to the support structure with a ball bearing or other suitable rotatable coupling. In other embodiments, the support structure 11 may comprise two or more rotation recess 33 which may be complementary and slightly larger in size and shape to the first 26 and second 27 ends of a rotationally coupled uncapping roller 21, 22. The first 26 and second 27 ends of each rotationally coupled uncapping roller 21, 22, may be received in the rotation recesses 33 thereby allowing the first 26 and second 27 ends to rotate within the rotation recesses 33 to be rotatably coupled to the support structure 11. In further embodiments, the first 26 and second 27 ends of each uncapping roller 21, 22, may comprise an axle 32 (FIG. 7B) which may rotatably couple the first 26 and second 27 ends of each uncapping roller 21, 22, to the support structure 11.

In preferred embodiments, one or more uncapping rollers 21, 22, may be rotatably coupled to the support structure 11 and also movably coupled to the support structure 11. For example, the first uncapping roller 21 and/or the second uncapping roller 22 may be rotatably coupled to the support structure 11 and also movably coupled to the support structure 11. By being rotatably coupled and also movably coupled to the support structure 11, an uncapping roller 21, 22, may be configured to rotate and to be movable relative to the other uncapping roller 21, 22, so that the distance between the two uncapping rollers 21, 22, defining the channel 31 width may be increased and decreased.

In some embodiments, the support structure 11 may comprise a slot 60 or oblong recess in the first minor wall 12 and another slot 60 opposingly positioned in the second minor wall 13. The height of the slots 29 may be less than the width of the slot 60. The height of the slots 29 may be generally complementary in size and shape to the first 26 and second 27 ends of an uncapping roller 21, 22, and the first 26 and second 27 ends of the uncapping roller 21, 22, may be received in the slots 29 thereby allowing the first 26 and second 27 ends to rotate within the slots 29 and to slide towards and away from the other uncapping roller 21, 22, along the width of the slots 29. In still further embodiments, the first 26 and second 27 ends of a movably coupled uncapping roller 21, 22, may comprise an axle 32 and the axles 32 may be movably coupled within two slots 29 of the support structure 11, thereby allowing the axles 32 to movably and rotatably couple the movable uncapping roller 21, 22, to the support structure 11. In alternative embodiments, any other rotatable and movable coupling methods may be used to allow a first 21 and/or second 22 uncapping roller to be rotatably coupled to the support structure 11 while being movable relative to the other uncapping roller 21, 22.

As shown in FIG. 2, in some embodiments, the device 100 may comprise a channel 31 for receiving a honeycomb frame 201 (FIGS. 3-6) having a honeycomb 202 (FIGS. 3-7A). The channel 31 may be formed between the first uncapping roller 21 and the second uncapping roller 22 such as between the projections 23 of the first uncapping roller 21 and projections 23 of the second uncapping roller 22. Preferably, the honeycomb frame 201 may be received by the frame depressions 28 and the honeycomb 202 may be received in the channel 31. In some embodiments, one or more projections 23 may be removably coupled to the first 21 and/or second 22 uncapping roller thereby allowing the length of the channel 31 to be increased or decreased to accommodate longer or shorter, respectively, honeycomb frames 201 and honeycombs 202.

In some embodiments, an uncapping roller 21, 22, may be movably coupled to the support structure 11 to allow the uncapping roller 21, 22, to be moved relative to the other uncapping roller 21, 22. By changing the distance between the uncapping rollers 21, 22, the width of the channel 31 may be increased or decreased to accommodate wider and narrower, respectively, honeycomb frames 201 and honeycombs 202. In preferred embodiments, a tensioning element 41 may be coupled to the first 21 and/or second 22 uncapping rollers which is configured to tension a movably coupled uncapping roller 21, 22, to the other uncapping roller 21, 22, thereby decreasing the width of the channel 31. In further preferred embodiments, a first tensioning element 41 and a second tension element 41 may be coupled to the first 21 and/or second 22 uncapping rollers which are configured to tension a movably coupled uncapping roller 21, 22, to the other uncapping roller 21, 22, thereby decreasing the width of the channel 31.

Preferably, a tensioning element 41 may be coupled to or proximate to a first end 26 and/or second end 27 of one or more uncapping rollers 21, 22. In some embodiments, a tensioning element 41 may comprise an elastic band or belt as shown in FIG. 2. An elastic band tensioning element 41 may be made from an elastic material, such as rubber, silicone rubber, elastic plastics, or any other material or combination or materials that are substantially able to regain their shape after deformation, and may be coupled to the first 21 and/or second 22 uncapping roller. The elastic band tensioning element 41 may resist deformation caused by moving a movably coupled uncapping roller 21, 22, away from the other uncapping roller 21, 22, thereby tensioning the uncapping rollers 21, 22, towards each other. In preferred embodiments, the uncapping rollers 21, 22, and or elastic band tensioning element 41 may comprise a non-stick coating or be made from a non-stick material, such as polytetrafluoroethylene (PTFE), so that the elastic band tensioning element 41 does not hinder the rotation of the uncapping rollers 21, 22.

In alternative embodiments, a tension element 41 may comprise a spring as shown in FIG. 1, optionally disposed within a slot 60, which may be coupled to a movably coupled uncapping roller 21, 22, to tension the movably coupled uncapping roller 21, 22, towards the other uncapping roller 21, 22. In further alternative embodiments, the device 100 may comprise a first spring tensioning element 41 coupled to a first 21 and/or second 22 uncapping roller, in which at least one of the uncapping rollers 21, 22, is movably coupled, and a second spring tensioning element 41 coupled to a first 21 and/or second 22 uncapping roller, thereby tensioning the movably coupled uncapping roller 21, 22, towards the other uncapping roller 21, 22. In some embodiments, one or more of the tension elements 41 may be adjustable, to allow the amount of tension in which the uncapping rollers 21, 22, are tensioned together to be adjusted, such as by being increased or decreased. For example, older honeycombs and/or colder temperatures may require greater tension to be exerted by one or more tension elements 41 for uncapping, while newer honeycombs and/or warmer temperatures may require less tension to be exerted by one or more tension elements 41 for uncapping. In still further embodiments, the distance between the slots 60 and rotation recesses 33 securing the uncapping rollers 21,22, and governing the width of the channel 31 may be spaced closer together for less tension and spaced farther apart to create more tension with a set screw or other device used to adjustably control the distance between the slots 60 and rotation recesses 33 securing the uncapping rollers 21,22.

In preferred embodiments, the uncapping rollers 21, 22, may be rotatably coupled to the support structure 11 and configured to freely rotate relative to each other. One or both of the uncapping rollers 21, 22, may also be movably coupled to the support structure 11 and tensioned towards the other uncapping roller 21, 22, with one or more tension elements 41 so that the channel 31 may comprise a width less than the width of a honeycomb 202 (FIGS. 3-7A) disposed within a honeycomb frame 201 (FIGS. 3-6). By moving the honeycomb 202 and frame 201 through the channel 31, the honeycomb 202 may press against the uncapping rollers 21, 22, pressing the projections 23 into the cappings of the honeycomb 202 as shown in FIG. 6, to rotate the first uncapping roller 21 and second uncapping roller 22 across the honeycomb 202.

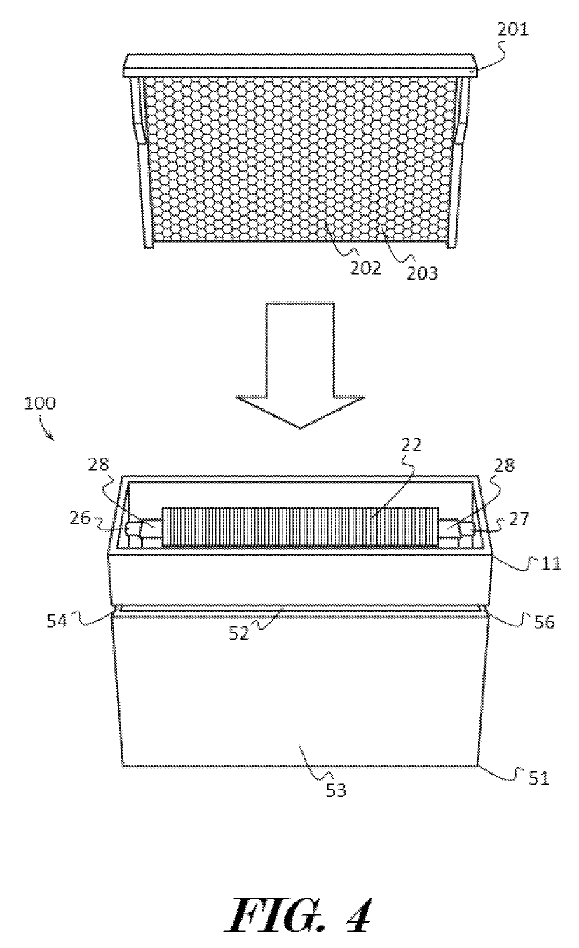

Turning now to FIGS. 4-6, in some embodiments, the device 100 may comprise a receptacle 51 with a cavity 52. The receptacle 51 may comprise a first 53, second 54, third 55, and fourth 56 sidewall which may be coupled to a base 57 to form a generally rectangular container which may define the cavity 52. In other embodiments, the receptacle 51 may be configured in any size and shape with any number of sidewalls. In preferred embodiments, the support structure 11 may be supported by the receptacle 51, such as by two or more sidewalls 53, 54, 55, 56, with the channel 31 in communication with the cavity 52. As a honeycomb 202 is moved through the channel 31 and uncapped, honey and wax removed from the honeycomb 202 may be caught or received in the cavity 52. The receptacle 51 may be made from any substantially rigid material suitable for supporting the support structure 11 and a honeycomb 202 disposed within a honeycomb frame 201. In further embodiments, the device 100 may comprise one or more legs 16 (FIG. 3) which may be coupled to the support structure 11 and which may extend away from the support structure 11. The legs 16 may support the support structure 11 above a surface, such as the ground, and/or they may contact or engage with portions of a receptacle 51, such as with portions of one or more or more sidewalls 53, 54, 55, 56, to stabilize the support structure 11 while it is being supported by the receptacle 51.

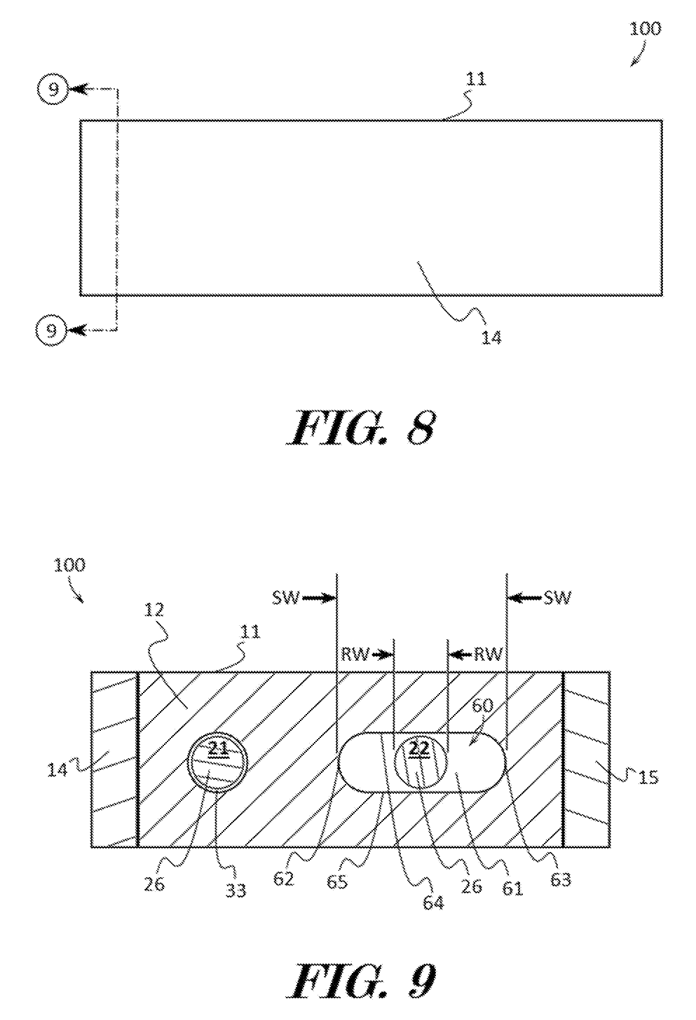

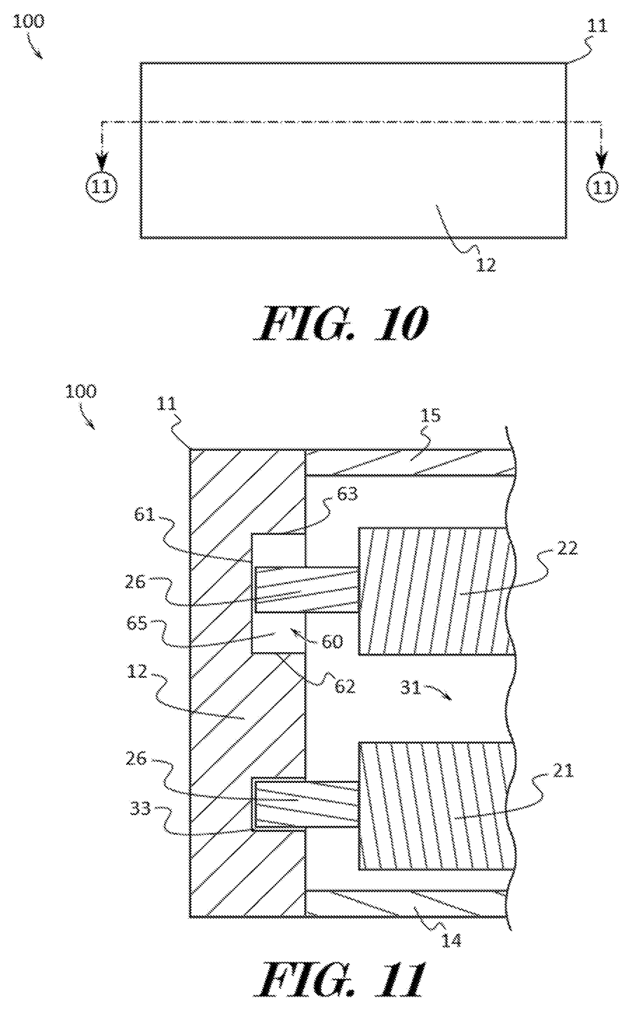

FIGS. 8-11 illustrate an example of a honeycomb uncapping device according to various embodiments described herein. In this example, the first roller 21 is rotatably coupled to the support structure 11 and the second roller 22 is rotatably and movably coupled to the support structure 11. One of skill in the art will recognize that preferably a first 21 and second 22 uncapping roller may be substantially similar with the designation of “first” and “second” merely facilitating the description that the device 100 may comprise two uncapping rollers. For this reason, a first uncapping roller 21 may be configured to function as a second uncapping roller and likewise a second uncapping roller 22 may be configured to function as a first uncapping roller. In some embodiments, the second uncapping roller 22 may be rotatably coupled to the first minor wall 12 and the first uncapping roller 21 may be rotatably and movably coupled to the first minor wall 12. In alternative embodiments, both uncapping rollers 21, 22, may be rotatably and movably coupled to the support structure 11.

As shown in the example device illustrated in FIGS. 8-11, the first uncapping roller 21 may be rotatably coupled to the first minor wall 12 and the second uncapping roller 22 may be rotatably and movably coupled to the first minor wall 12. The first end 26 of the first roller 21, optionally comprising a bearing, axle 32 (FIG. 7B) or other friction reducing device, may be inserted into a rotation recess 33 in the minor wall 12. The rotation recess 33 may be complementary in shape while being slightly larger than the first end 26 of the first roller 21 to allow the first end 26 to rotate freely within the rotation recess 33. The first end 26 of the second roller 22, optionally comprising a bearing, axle 32 or other friction reducing device, may be inserted into a slot 60 in the minor wall 12. The slot 60 may comprise a slot inner edge 61 which may be configured to arrest the lateral (side to side) movement of the first end 26 of the second roller 22 while allowing the first end 26 of the second roller 22 to move longitudinally (towards and away) from the proximal longitudinal arrest sidewall 62 and distal longitudinal arrest sidewall 63 and therefore towards and away from the first roller 21. The proximal longitudinal arrest sidewall 62 may be closer to the first end 26 of the first uncapping roller 21 and configured to stop the longitudinal movement of the first end 26 of the second uncapping roller 22 towards the first uncapping roller 21. The distal longitudinal arrest sidewall 63 may be farther from the first end 26 of the first uncapping roller 21 and configured to stop the longitudinal movement of the first end 26 of the second uncapping roller 22 away from the first uncapping roller 21.

The slot 60 may also comprise a slot top sidewall 64 and a slot bottom sidewall 65 both of which may be separated from each other by a distance that is slightly greater than the width dimension (RW) of the first end 26 of the second roller 22 to limit the vertical movement of the second end 26 of the second roller 22 between the slot top sidewall 64 and a slot bottom sidewall 65, while allowing the second end 26 of the second roller 22 to rotate between the slot top sidewall 64 and a slot bottom sidewall 65. Likewise, the proximal longitudinal arrest sidewall 62 and the distal longitudinal arrest sidewall 63 may be separated from each other by a width dimension (SW) that is greater than the width dimension (RW) of the first end 26 of the second roller 22. In some embodiments, the SW of the proximal longitudinal arrest sidewall 62 and the distal longitudinal arrest sidewall 63 may be 10% to 1,000% the RW of the first end 26 of the second roller 22. In preferred embodiments, the SW of the proximal longitudinal arrest sidewall 62 and the distal longitudinal arrest sidewall 63 may be greater than or equal to 200% the RW of the first end 26 of the second roller 22. In this manner the first end 26 of the second roller 22 may be movably coupled longitudinally relative to the first uncapping roller 21 and rotatably coupled to the support structure 11 within the slot 60. In alternative embodiments, one or more of the slots 60 may not comprise a slot inner edge 61 and therefore may pass completely through the minor walls 12, 13.

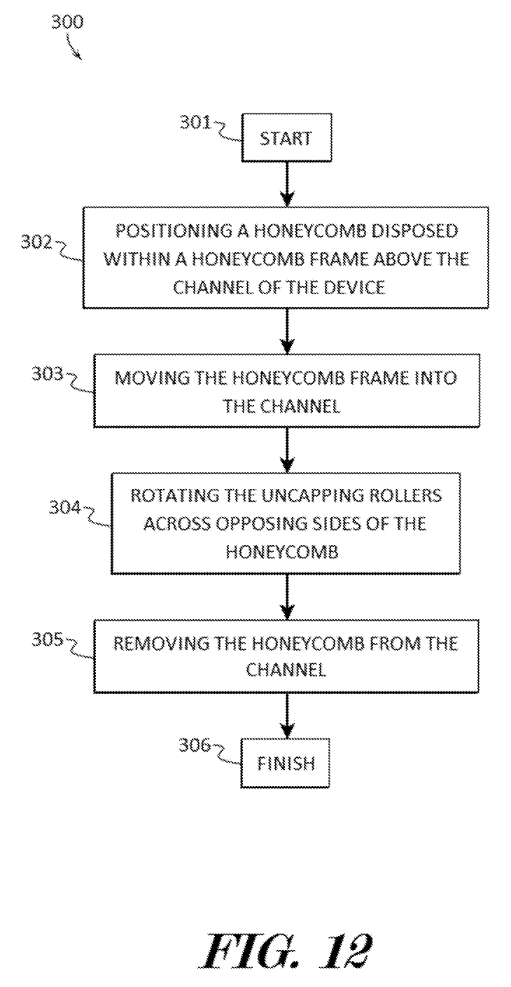

FIG. 12 illustrates a block diagram of an example of a method for uncapping a honeycomb (“the method”) 300 according to various embodiments described herein. The methods 300 may be used to remove cappings from a honeycomb 202 (FIGS. 3-7) disposed within a honeycomb frame 201 (FIGS. 3-6) as the honeycomb 202 is moved through the channel 31 (FIG. 2) of a honeycomb uncapping device 100 (FIGS. 1-6).

In some embodiments, the method 300 may start 301 and a honeycomb 202 disposed within a honeycomb frame 201 may be positioned above the channel 31 of the device 100 in step 302. In preferred embodiments, the uncapping rollers 21, 22, of the device 100 may be oriented in a horizontal plane parallel to the ground and the honeycomb 202 and honeycomb frame 201 may be vertically oriented above the channel 31 perpendicularly to the horizontal plane of the uncapping rollers 21, 22.

In step 302, the honeycomb frame 201 comprising the honeycomb 202 may be moved into the channel 31. In some embodiments, the honeycomb frame 201 may be pressed into the channel 31 thereby separating the uncapping rollers 21, 22, which may be tensioned towards each other by one or more tensioning elements 41. As the honeycomb frame 201 and honeycomb 202 are moved into the channel 31, the uncapping rollers 21, 22, may be tensioned or pressed into contact with the opposing sides of the honeycomb 202 within the honeycomb frame 201.

Next in step 304, the uncapping rollers 21, 22, may be rotated across the opposing sides of the honeycomb 202. In preferred embodiments, each uncapping roller 21, 22, may comprise a frame depression 28 bounding the plurality of projections 23 the respective uncapping roller 21, 22. The frame depressions 28 and the projections 23 may be positioned on the uncapping rollers 21, 22, so that the wider honeycomb frame 201 is received by the frame depressions 28 while the opposing sides of the narrower honeycomb 202 are allowed to contact and press against the projections 23 of the uncapping rollers 21, 22. In this manner as the honeycomb 202 and honeycomb frame 201 are moved through the channel 31, the freely rotating uncapping rollers 21, 22, may be frictionally engaged by the honeycomb 201 to rotate across the opposing side of the honeycomb 202. Preferably, the device 100 may be positioned over a receptacle 51 with a cavity 52 so that honey and wax cappings removed by the projections 23 of the uncapping rollers 21, 22, may be collected in the cavity 52 of the receptacle 51.

In step 305, the honeycomb 202, and therefore the honeycomb frame 201, may be removed from the channel 31. In some embodiments, the honeycomb 202 may be removed from the channel 31 by moving the honeycomb 31 completely through the channel 31 to remove the honeycomb 202, and therefore the honeycomb frame 201, from below the uncapping rollers 21, 22. In other embodiments, the honeycomb 202 may be removed from the channel 31 by moving the honeycomb 31 almost completely down through the channel 31 and then pulling it back up and out of the channel 31 to remove the honeycomb 202, and therefore the honeycomb frame 201, from above the uncapping rollers 21, 22. After the honeycomb 202, and therefore the honeycomb frame 201, has been removed from the channel 31, the method 300 may finish 306.

While some materials have been provided, in other embodiments, the elements that comprise the device 100 such as the support structure 11, uncapping rollers 21, 22, projections 23, optional tensioning element 41, optional receptacle 51, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A honeycomb uncapping device for uncapping wax from both sides of a honeycomb disposed within a honeycomb frame, the device comprising:
a support structure;
a first uncapping roller rotatably coupled to the support structure, wherein the first uncapping roller comprises a plurality of projections that radiate away from the first uncapping roller;
a second uncapping roller, wherein the second uncapping roller is rotatably coupled to the support structure, wherein the second uncapping roller is movably coupled to the support structure to allow the second roller to be moved relative to the first uncapping roller, and wherein the second uncapping roller comprises a plurality of projections that radiate away from the second uncapping roller;
a channel for receiving a honeycomb frame having a honeycomb, wherein the channel is formed between the first uncapping roller and the second uncapping roller; and
a first tensioning element coupled to the second uncapping roller, wherein the first tensioning element tensions the second uncapping roller towards the first uncapping roller to tension the first uncapping roller and the second uncapping roller into contact with opposing sides of the honeycomb as the honeycomb frame is moved through the channel.

2. The device of claim 1, wherein the first roller is movably coupled to the support structure to allow the first roller to be moved relative to the second uncapping roller.

3. The device of claim 1, wherein the first tension element is coupled to the first uncapping roller and to the second uncapping roller.

4. The device of claim 1, further comprising a second tensioning element.

5. The device of claim 4, wherein the second tension element is coupled to the first uncapping roller and to the second uncapping roller.

6. The device of claim 4, wherein the projections of the first uncapping roller are cylindrical and encircle the first uncapping roller.

7. The device of claim 4, wherein the projections of the second uncapping roller are cylindrical and encircle the second uncapping roller.

8. The device of claim 1, wherein the first and second uncapping rollers each comprise two frame depressions bounding the plurality of projections.

9. The device of claim 1, wherein a honeycomb disposed within a honeycomb frame moved through the channel rotates the first uncapping roller and second uncapping roller across the honeycomb.

10. The device of claim 1, further comprising a receptacle with a cavity, wherein the receptacle supports the support structure with the channel in communication with the cavity.

11. A honeycomb uncapping device for uncapping wax from both sides of a honeycomb disposed within a honeycomb frame, the device comprising:
a support structure;
a first uncapping roller rotatably coupled to the support structure, wherein the first uncapping roller comprises a plurality of projections that radiate away from the first uncapping roller;
a second uncapping roller, wherein the second uncapping roller is rotatably coupled to the support structure, wherein the second uncapping roller is movably coupled to the support structure to allow the second roller to be moved relative to the first uncapping roller, and wherein the second uncapping roller comprises a plurality of projections that radiate away from the second uncapping roller;
a channel for receiving a honeycomb frame having a honeycomb, wherein the channel is formed between the first uncapping roller and the second uncapping roller; and
a first tensioning element coupled to the second uncapping roller, wherein the first tensioning element tensions the second uncapping roller towards the first uncapping roller to tension the first uncapping roller and the second uncapping roller into contact with opposing sides of the honeycomb as the honeycomb frame is moved through the channel, and wherein moving the honeycomb and the honeycomb frame through the channel rotates the first uncapping roller and second uncapping roller across the honeycomb.

12. The device of claim 12, wherein the first roller is movably coupled to the support structure to allow the first roller to be moved relative to the second uncapping roller.

13. The device of claim 12, wherein the first tension element is coupled to the first uncapping roller and to the second uncapping roller.

14. The device of claim 12, wherein the first tension element comprises an elastic band.

15. The device of claim 12, further comprising a second tensioning element.

16. The device of claim 15, wherein the second tension element is coupled to the first uncapping roller and to the second uncapping roller.

17. The device of claim 15, wherein the projections of the first uncapping roller are cylindrical and encircle the first uncapping roller.

18. The device of claim 15, wherein the projections of the second uncapping roller are cylindrical and encircle the second uncapping roller.

19. The device of claim 12, wherein the first and second uncapping rollers each comprise two frame depressions bounding the plurality of projections.

20. The device of claim 12, further comprising a receptacle with a cavity, wherein the receptacle supports the support structure with the channel in communication with the cavity.
